(19) United States
(12) Patent Application Publication
(10) Pub. No.: US 2024/0129174 A1
(43) Pub. Date: Apr. 18, 2024

(54) UNEQUAL MODULATION AND CODING SCHEME FOR PROBABILISTIC CONSTELLATION SHAPING IN WLANS

(71) Applicants: Qinghua Li, San Ramon, CA (US); Hao Song, Santa Clara, CA (US); Juan Fang, Portland, OR (US); Shlomi Vituri, Tel Aviv (IL); Assaf Gurevitz, Ramat Hasharon (IL); Danny Alexander, Neve Efraim Monoson (IL); Robert J. Stacey, Portland, OR (US)

(72) Inventors: Qinghua Li, San Ramon, CA (US); Hao Song, Santa Clara, CA (US); Juan Fang, Portland, OR (US); Shlomi Vituri, Tel Aviv (IL); Assaf Gurevitz, Ramat Hasharon (IL); Danny Alexander, Neve Efraim Monoson (IL); Robert J. Stacey, Portland, OR (US)

(21) Appl. No.: 18/397,940

(22) Filed: Dec. 27, 2023

(51) Int. Cl. H04L 27/34; H04L 27/36

(52) U.S. Cl. CPC H04L 27/3405; H04L 27/36; H04W 84/12

(57) ABSTRACT

A station (STA) configured for operation in a wireless local area network (WLAN) may implement an unequal Modulation and Coding Scheme (MCS) for Probabilistic Constellation Shaping using first and second shaping encoders. The first shaping encoder may encode a first segment of input bits for a first modulation order and generate a first shaped bit stream and the second shaping encoder may encode a second segment of input bits for a second modulation order to generate a second shaped bit stream. A first QAM symbol stream may be generated at least from the first shaped bit stream and from parity bits using the first modulation order and a second QAM symbol stream may be generated at least from the second shaped bit stream and from parity bits using the second modulation order. The STA may generate the parity bits from the first and second shaped bit streams with one or more LDPC encoders and may transmit the first and second QAM symbol streams within a PPDU.

### TECHNICAL FIELD

Embodiments pertain to wireless communications.

### BACKGROUND

Future wireless local area networks (WLANS) (e.g., Wi-Fi 8 and beyond) are expected to achieve higher performance levels that conventional WLANS. These higher performance level may include higher-data rates, improved spectral efficiency, and improved network efficiencies. One technique to improve WLAN performance is constellation shaping. Constellation shaping improves spectral efficiency and provides an effective way to improve throughput, resilience, latency and efficiency in WLANs. Another technique to improve WLAN performance is unequal modulation and coding (UMC). UMC delivers significant performance gains and, for example, allows the use of higher order modulations and higher code rates for devices with good channel conditions.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates probabilistic constellation shaping, in accordance with some embodiments.

FIG. 7A illustrates a first unequal modulation and coding scheme, in accordance with some embodiments.

FIG. 7B illustrates a second unequal modulation and coding scheme, in accordance with some embodiments.

FIG. 8A illustrates a first constellation shaping with unequal MCS scheme, in accordance with some embodiments.

FIG. 8B illustrates a second constellation shaping with unequal MCS scheme, in accordance with some embodiments.

FIG. 9 illustrates a procedure for Unequal Modulation and Coding Scheme (MCS) for Probabilistic Constellation Shaping, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Unequal modulation and coding scheme (MCS) and probabilistic constellation shaping are two promising techniques for Wi-Fi 8. Conventionally, only equal MCS is used in probabilistic constellation shaping. Since it is very likely that unequal MCS will be adopted by Wi-Fi 8 (i.e., IEEE 802.11bn based Wi-Fi), constellation shaping needs to be upgraded to support unequal MCS. Embodiments disclosed herein for constellation shaping outperform unequal MCS without constellation shaping.

Some embodiments disclosed herein employ multiple shaping encoders and multiple QAM modulators that may have different constellation orders, respectively. In some embodiments, a shaping encoder is associated with each order of QAM. In these embodiments, the output bits of the shaping encoder are sent to the corresponding QAM modulator as amplitude bits. In these embodiments, the output bits of all shaping encoders are sent to one FEC encoder as systematic bits. In these embodiments, the parity bits generated by the FEC encoder are sent to the QAM modulators and used as sign bits mostly. These embodiments as well as others are described in more detail herein.

Some embodiments are directed to a station (STA) configured for operation in a wireless local area network (WLAN) that may implement an unequal Modulation and Coding Scheme (MCS) for Probabilistic Constellation Shaping using first and second shaping encoders. The first shaping encoder may encode a first segment of input bits for a first modulation order and generate a first shaped bit stream and the second shaping encoder may encode a second segment of input bits for a second modulation order to generate a second shaped bit stream. A first QAM symbol stream may be generated at least from the first shaped bit stream and from parity bits using the first modulation order and a second QAM symbol stream may be generated at least from the second shaped bit stream and from parity bits using the second modulation order. The STA may generate the parity bits from the first and second shaped bit streams with one or more LDPC encoders and may transmit the first and second QAM symbol streams within a physical layer protocol data unit (PPDU).

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM CIRCUITRY 104A and FEM CIRCUITRY 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

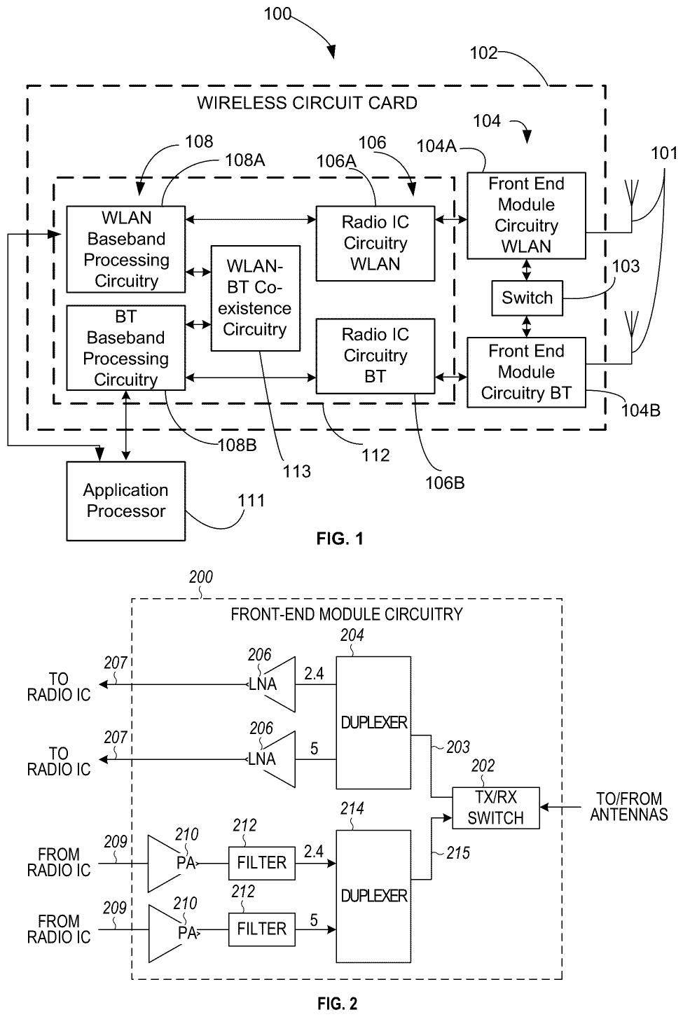

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

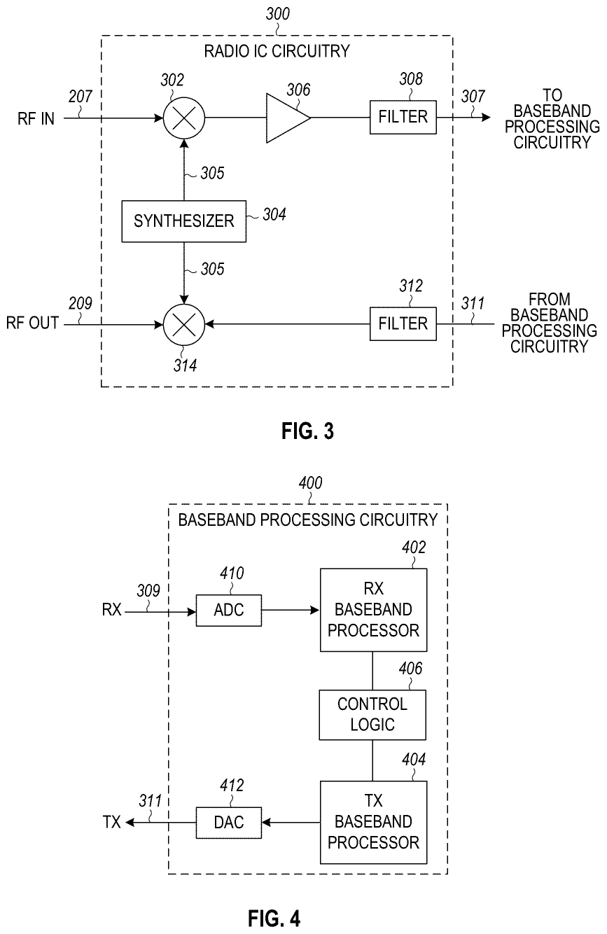

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

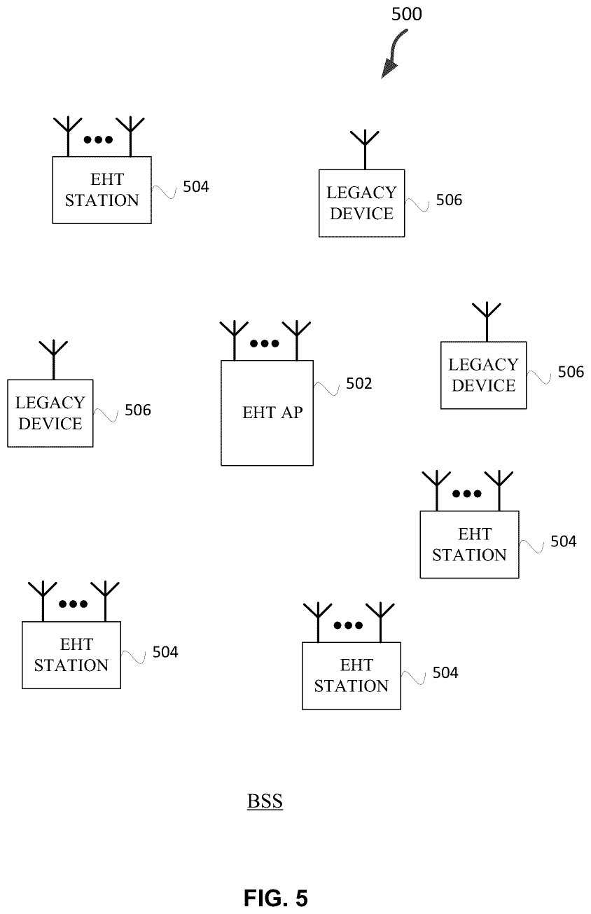

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 and stations 504 may be EHT STAs. In some embodiments, WLAN 500 may be configured for Ultra-High Rate (UHR) communications in accordance with one of the IEEE 802.11 standards or draft standards and one or more stations including AP 502 and stations 504 may be UHR and/or UHR+ STAs.

In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIIVIO). There may be more than one AP 502 that is part of an extended service set (ESS). A controller (not illustrated) may store information that is common to the more than one APs 502.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be several types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIIVIO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a primary station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIIVIO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) and/or UL OFDMA TXOP. In some embodiments, the trigger frame may include a DL UL-MU-MIIVIO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a station 504 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the Stations 504, AP 502, an apparatus of the Stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, the AP and STAs may communicate in accordance with one of the IEEE 802.11 standards. IEEE Std 802.11-2020, IEEE P802.11ax/D8.0, October 2020, IEEE P802.11REVmd/D5.0, IEEE P802.11be/D3.0, January 2023 and IEEE P802.11-REVme/D1.3 are incorporated herein by reference in their entireties.

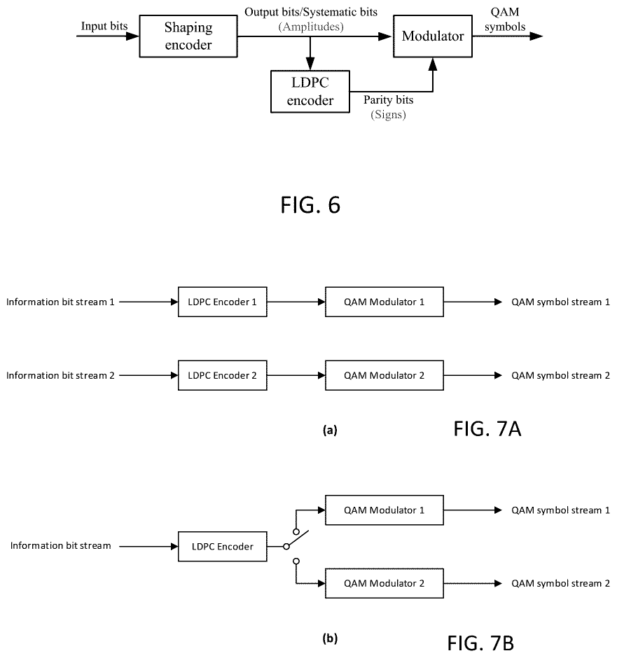

Probabilistic constellation shaping is illustrated in FIG. 6. The input payload bits are first encoded by the shaping encoder, whose example is shown in Table 1. Bit segments with different lengths are converted into bit tuples of a fixed length, e.g., 5 bits for 4K-QAM and 4 bits for 1K-QAM. Each bit tuple specifies (or is mapped to) an amplitude of the I or Q component of the quadrature amplitude modulation (QAM) constellation at the QAM modulator. For protecting these amplitude bits, an FEC encoder, e.g., LDPC, is employed. The FEC encoder takes the bit tuples as its input and generates parity bits as its output. The generated parity bits are used as the sign bits by the QAM modulator. For example, amplitude bit tuple 01111 is mapped to amplitude 1, and sign bit 0 assigns a positive polarity to the amplitude such that these six bits 011110 are represented by +1 in an I or Q component of 4K-QAM constellation.

TABLE 1
Shaping encoder for 4K-QAM.

| Input bits | Amplitude | Probability | Output bits |
|---|---|---|---|
| 0000 | 1 | 1/16 | 01111 |
| 0001 | 3 | 1/16 | 01110 |
| 0010 | 5 | 1/16 | 01100 |
| 0011 | 7 | 1/16 | 01101 |
| 0100 | 9 | 1/16 | 01001 |
| 0101 | 11 | 1/16 | 01000 |
| 0110 | 13 | 1/16 | 01010 |
| 0111 | 15 | 1/16 | 01011 |
| 1000 | 17 | 1/16 | 00011 |
| 1001 | 19 | 1/16 | 00010 |
| 10100 | 21 | 1/32 | 00000 |
| 10101 | 23 | 1/32 | 00001 |
| 10110 | 25 | 1/32 | 00101 |
| 10111 | 27 | 1/32 | 00100 |
| 11000 | 29 | 1/32 | 00110 |
| 11001 | 31 | 1/32 | 00111 |
| 11010 | 33 | 1/32 | 10111 |
| 11011 | 35 | 1/32 | 10110 |
| 111000 | 37 | 1/64 | 10100 |
| 111001 | 39 | 1/64 | 10101 |
| 111010 | 41 | 1/64 | 10001 |
| 111011 | 43 | 1/64 | 10000 |
| 111100 | 45 | 1/64 | 10010 |
| 111101 | 47 | 1/64 | 10011 |
| 1111100 | 49 | 1/128 | 11011 |
| 1111101 | 51 | 1/128 | 11010 |
| 1111110 | 53 | 1/128 | 11000 |
| 11111110 | 55 | 1/256 | 11001 |
| 111111110 | 57 | 1/512 | 11101 |
| 111111111 | 59 | 1/512 | 11100 |
| — | 61 | 0 | — |
| — | 63 | 0 | — |

Two variants of unequal modulation and coding schemes are illustrated in FIG. 7A and FIG. 7B. In FIG. 7A, scheme (a) is shown. Multiple FEC encoders, e.g., LDPC encoders are employed. The code rates of the FEC encoders can be different or the same. The output of each FEC encoder is sent to a corresponding modulator, e.g., QAM modulator. This scheme provides the most flexibility at the cost of complexity. In FIG. 7B, scheme (b) is shown. Only one FEC encoder with one code rate is employed. The output bits of the FEC encoder are distributed to multiple modulators with the same or different modulation orders. This scheme is also called unequal modulation because the FEC coding scheme is the same for all QAM symbol streams and only the modulation orders can be different.

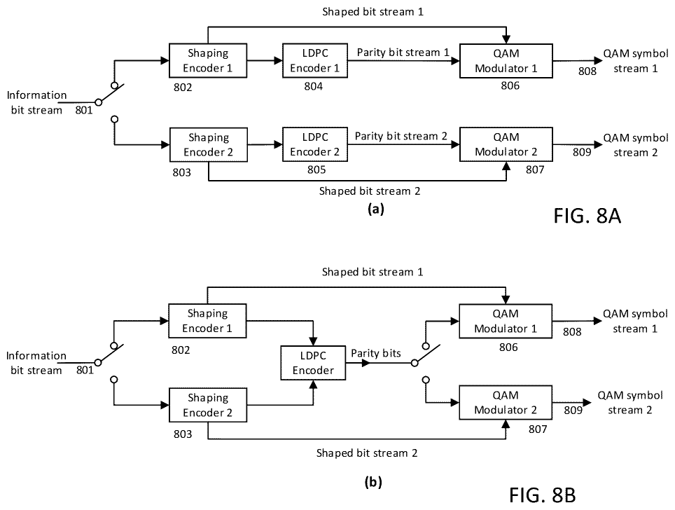

Two Constellation Shaping with Unequal MCS schemes are illustrated in FIG. 8A and FIG. 8B. Multiple shaping encoders are used. Each of them is designed of one QAM order. For example, the shaping encoder in Table 1 is designed for 4K-QAM. The output bits of the shaping encoder, called shaped bits, are divided into 5-bit tuples each of which representing an I or Q component's amplitude of 4K-QAM symbol. When there are multiple QAM modulators with different orders are used, there may be multiple shaping encoders that are designed for the QAM orders, respectively.

In FIG. 8A, multiple FEC encoders, e.g., LDPC encoders, are employed such that different FEC code rates can be supported for each parity bit stream at the cost of high complexity. The receiver needs to synchronize the decoding of the multiple FEC decoders for putting the decoded bits in order before reporting them to the MAC layer.

In FIG. 8B, a single FEC encoder is used. The FEC encoder takes shaped bits, which are the output bits of the shaping encoders, from multiple shaping encoders to generate the parity bits. The parity bits are then distributed to the QAM modulators for generating QAM symbols. In some embodiment, the same parity bit may be sent to multiple modulators. Because only one FEC decoder is needed, there is no need to synchronize the decoding of multiple FEC decoders such that the complexity is reduced. Since only one FEC encoder is used, QAM symbol streams share the same code rate even though the QAM orders can be different. This scheme extends the unequal modulation in FIG. 7B.

The embodiments illustrated in FIG. 8A and FIG. 8B can be modified to include those rate adaptation techniques. Code rate adaptation may be used to fill the allocated OFDM symbols or to enhance the FEC protection. In these embodiments, shaping techniques may be used for increasing and decreasing the FEC code rates, respectively. For example, in the embodiments illustrated in FIG. 8A and FIG. 8B, some of the information bits may bypass the shaping encoders and may be used as the sign bits in the QAM modulators. For combating the channel fading, those information bits are still sent to the FEC encoder(s) as systematic bits for generating parity bits. For another example, besides the shaped amplitudes generated by the shaping encoder(s), the QAM modulator in FIG. 8A and FIG. 8B or an additional QAM modulator can take uniformly distributed amplitudes as UQ components. The uniformly distributed amplitudes are generated from part of the information bits (that are encoded as LDPC systematic bits) or part of the parity bits, both of which are uniformly distributed. Unlike those generated by shaped amplitudes, the QAM symbols or UQ components generated by the uniform QAM modulation are uniformly distributed, which don't provide shaping gain. Using both the shaped and uniform QAM symbols or UQ components provides not only the flexibility to vary the effective code rate and to fill up the allocated OFDM symbols but also a tradeoff between FEC gain and shaping gain.

The QAM symbol streams in FIG. 8A and FIG. 8B can be sent to different spatial streams or different frequency subbands (like RU or RU component in mRU), respectively.

As illustrated in FIGS. 8A and 8B, a station (STA) configured for operation in a wireless local area network (WLAN) may implement an unequal Modulation and Coding Scheme (MCS) for Probabilistic Constellation Shaping. In these embodiments, the STA may perform probabilistic constellation shaping using first and second shaping encoders 802, 803. The first shaping encoder 802 may be configured to encode a first segment of input bits 801 for a first modulation order and generate a first shaped bit stream. The second shaping encoder 803 may be configured to encode a second segment of input bits 801 for a second modulation order to generate a second shaped bit stream. The STA may also generate a first QAM symbol stream 808 with a first QAM modulator 806 and a second QAM symbol stream 809 with a second QAM modulator 807. In these embodiments, the first QAM symbol stream 808 may be generated at least from the first shaped bit stream and from parity bits using the first modulation order. In these embodiments, the second QAM symbol stream may be generated at least from the second shaped bit stream and from parity bits using the second modulation order. In these embodiments, the STA may generate the parity bits from the first and second shaped bit streams with one or more forward-error correction (FEC) encoders 804, 805. In these embodiments, the STA may transmit the first and second QAM symbol streams 808, 809 within a PPDU.

In some embodiments, the processing circuitry of the UE may be configured to either increase or decrease an encoding rate of the one or more FEC encoders for filling allocated OFDM symbols since the transmission resource is allocated in OFDM symbols, not I or Q component of QAM symbol. For example, for 20 MHz bandwidth, each OFDM symbol has 234 data subcarrier and each subcarrier have one I and one Q component of a QAM symbol. The number of I/Q components depends on the input information bits. The allocated OFDM symbols should have enough subcarriers to send all the I/Q components. However, there is usually some leftover subcarriers, which may be filled. For example, two OFDM symbols have 468 subcarriers but the generated QAM symbols from the input information bits may only fill 1 and a half OFDM symbols. The leftover ½ OFDM symbol may be filled up by the repetition of the generated UQ components or UQ components that carry additional parity bits or repeated parity bits. In some opposite cases, we may need to remove some generated UQ components or UQ components carrying parity bits so that the remaining UQ components can fit into the allocated OFDM symbols.

In some embodiments, the probability indicated in Table 1 may provide some information for estimating the average transmission power. In Table 1, the larger amplitude may be used to carry more input information bits and is transmitted less often so that the average transmission power can be reduced. In conventional modulation, each amplitude carries the same number of input information bits. The average transmission power is higher than the shaping modulation. In some embodiments, the shaping encoder may operate as a lookup table and may read or search the input information bit stream sequentially. Once it finds a segment of bits match an entry of input bits in the table, it sends out the corresponding output amplitude or output bits and continues the search in the remaining input information bits. For a given number of input information bits, e.g., 1000 bytes, the shaping encoder doesn't know how many output bits will be got until the end of the shaping encoding. The number of output bits depends on the specific input information bit sequence.

The amplitudes in a constellation shaping table are picked from the I or Q component of the conventional QAM constellation like 64QAM, 256QAM, 1024QAM, and 4096QAM. The probability of each information bit tuple is determined by the number of information input bits of the bit tuple. For example, information bit tuple 000 has a probability of 2\hat{ }(−3)=⅛, where 3 is the number of bits. For another example, information bit tuple 1111110 has a probability of 2\hat{ }(−7)= 1/128, where 7 is the number of bits. The probability represents how often the corresponding amplitude is used in the shaped transmission.

In some embodiments, for non-trigger based transmission, there may be an indication in the PPDU preamble which specifies the modulations and code rate of each QAM symbol stream. In addition, there should be another indication to specify the constellation shaping. The two indications may be combined into one indication. The indications may be in a SIGNAL field and in some embodiments, may be in the user field inside the SIGNAL field. For trigger-based transmission, an access point may send a soliciting frame for the uplink data transmission. The MCS of the uplink data transmission may be specified in the trigger frame. In some embodiments, the MCS indications for the shaping and unequal MCS may be included in a user info field inside the trigger frame.

Some embodiments are directed to a station (STA) configured for operation in a wireless local area network (WLAN). To implement an unequal Modulation and Coding Scheme (MCS) for Probabilistic Constellation Shaping, STA may perform probabilistic constellation shaping using first and second shaping encoders. In these embodiments, the STA may include processing circuitry to configure the first shaping encoder to encode a first segment of input bits for a first modulation order and generate a first shaped bit stream. In these embodiments, the processing circuitry may also configure the second shaping encoder to encode a second segment of input bits for a second modulation order to generate a second shaped bit stream.

In these embodiments, the processing circuitry may also configure the STA to generate a first QAM symbol stream with a first QAM modulator. In these embodiments, the first QAM symbol stream may be generated at least from the first shaped bit stream and from parity bits using the first modulation order. In these embodiments, the processing circuitry may also configure the STA to generate a second QAM symbol stream from at least from the second shaped bit stream and from parity bits using the second modulation order.

In these embodiments, the processing circuitry may also configure the STA to generate the parity bits from the first and second shaped bit streams with one or more forward-error correction (FEC) encoders and cause the STA to transmit the first and second QAM symbol streams within a PPDU.

In some embodiments, the first QAM symbol stream may be generated using some of the input bits (i.e., unshaped bits) of the first group in addition to the first shaped bit stream. In these embodiments, the second QAM symbol stream may be generated using some of the input bits (i.e., unshaped bits) of the second group in addition to the second shaped bit stream, although the scope of the embodiments is not limited in this respect.

In some embodiments, the processing circuitry may encode the PPDU to indicate that unequal MCS for probabilistic constellation shaping is to generate the first and second QAM symbol streams.

In some embodiments, for the probabilistic constellation shaping the first shaping encoder determines amplitude bit tuples of a first fixed length for the first shaped bit stream by matching segments of the input bits of different lengths with table entries of a constellation shaping table for the first modulation order, and the second shaping encoder determines amplitude bit tuples of a second fixed length for the second shaped bit stream by matching segments of the input bits of different lengths with table entries of a constellation shaping table for the second modulation order. In these embodiments, when the first and second modulation orders are different, the first and second fixed lengths are different.

In some embodiments, when the first modulation order is 4K-QAM (4096-QAM), the first fixed length for the amplitude bit tuples determined by the first shaping encoder is five bits. In these embodiments, when the second modulation order is 1K-QAM (1024-QAM), the second fixed length for the amplitude bit tuples determined by the second shaping encoder is four bits.

Table 1 illustrates an example of a constellation shaping table for a 4K-QAM modulation order. In this example, the shaping encoder may match segments of input bits of different lengths with the table entries in the first column (i.e., the input bits column) to determine a corresponding amplitude bit tuple in the output bits column. In this example, the amplitude bit tuples shown the output bits column have a fixed length of five bits while the number of bits in the segments of inputs bits varies from four to nine as shown in the input bit column.

In some embodiments, each amplitude bit tuple determined by the first shaping encoder is mapped to an amplitude of an I or Q component of a QAM constellation of the first QAM modulator. in these embodiments, each amplitude bit tuple determined by the second shaping encoder is mapped to an amplitude of an I or Q component of a QAM constellation of the second QAM modulator.

In some embodiments, the one or more FEC encoders may comprise one or more Low-Density Parity-Check (LDPC) encoders configured to generate parity bits for use as sign bits by the first and second QAM modulators. In these embodiments, the first and second QAM modulators may also be configured to use at least some input bits bypassing the shaping encoder as additional sign bits to help increase the effective code rate. In some embodiments, some part of the parity bits may be used as amplitude bits to be mapped to UQ amplitudes as well for reducing the effective code rate, although the scope of the embodiments is not limited in this respect.

In some embodiments, the one or more FEC encoders may comprise a single Low-Density Parity-Check (LDPC) encoder configured to generate the parity bits for use as sign bits by both the first and second QAM modulators. In these embodiments, symbols of the first QAM symbol stream and symbols of the second QAM symbol stream have the same FEC code rate even though their modulation orders are different. An example of this embodiment using a single LDPC encoder is illustrated in FIG. 8B.

In some embodiments, the one or more FEC encoders may comprise a first and a second Low-Density Parity-Check (LDPC) encoder. In these embodiments, the first LDPC encoder may be configured to generate a first parity bit stream from the first shaped bit stream for use as sign bits by the first QAM modulator. In these embodiments, the second LDPC encoder may be configured to generate a second parity bit stream from the second shaped bit stream for use as sign bits by the second QAM modulator. In some embodiments, the first LDPC encoder may use a first LDPC code rate and the second LDPC encoder may use a second LDPC code rate.

In these embodiments, the processing circuitry may configure the first and second LDPC encoders to use different LDPC code rates. In these embodiments, symbols of the first QAM symbol stream may have the first LDPC code rate and symbols of the second QAM symbol stream may have the second LDPC code rate. An example of an embodiment using two separate LDPC encoders is illustrated in FIG. 8A. In some embodiments, the processing circuitry may be configured to either increase or decrease an encoding rate of the one or more of the FEC encoders for filling allocated OFDM symbols.

In some embodiments, the first and second QAM symbol streams may be configured for transmission by the STA, respectively, in first and second spatial streams. In some embodiments, the first and second QAM symbol streams may be configured for transmission by the STA, respectively, in first and second frequency subbands. In some embodiments, the first and second QAM symbol streams may be configured for transmission by the STA, respectively, in first and second resource units (RUs) of a multiple resource unit (MRU) transmission.

In some embodiments, for non-trigger based transmissions to indicate that unequal MCS for probabilistic constellation shaping is used to generate the first and second QAM symbol streams, the processing circuitry may be configured to encode a preamble of the PPDU to specify constellation shaping and indicate the modulation orders and code rate of the each of the QAM symbol streams in a user field of a signal field (SIG) of the PPDU.

In some embodiments, the STA may be a ultra high rate (UHR) station and the PPDU may be encoded as a UHR PPDU. In these embodiments, the preamble of the UHR PPDU may be encoded to specify constellation shaping and indicate the modulation orders and code rate of the each of the QAM symbol streams in a user field of a UHR signal field (UHR-SIG) of the UHR PPDU.

In some embodiments, when the STA is operating as a receiving STA, and wherein to decode first and second QAM symbol streams received from a transmitting STA when an unequal Modulation and Coding Scheme (MCS) for Probabilistic Constellation Shaping is implemented using two or more FEC encoders, the processing circuitry may synchronize decoding for ordering decoded bits before reporting the decoded bits to a MAC layer of the STA. In some embodiments, the STA is one of an access point station (AP) and a non-Access Point station (non-AP STA) (i.e., a client station).

Some embodiments are directed to a non-transitory computer-readable storage medium that stores instructions for execution by processing circuitry a station (STA) to configure the device implement an Unequal Modulation and Coding Scheme (MCS) for Probabilistic Constellation Shaping.

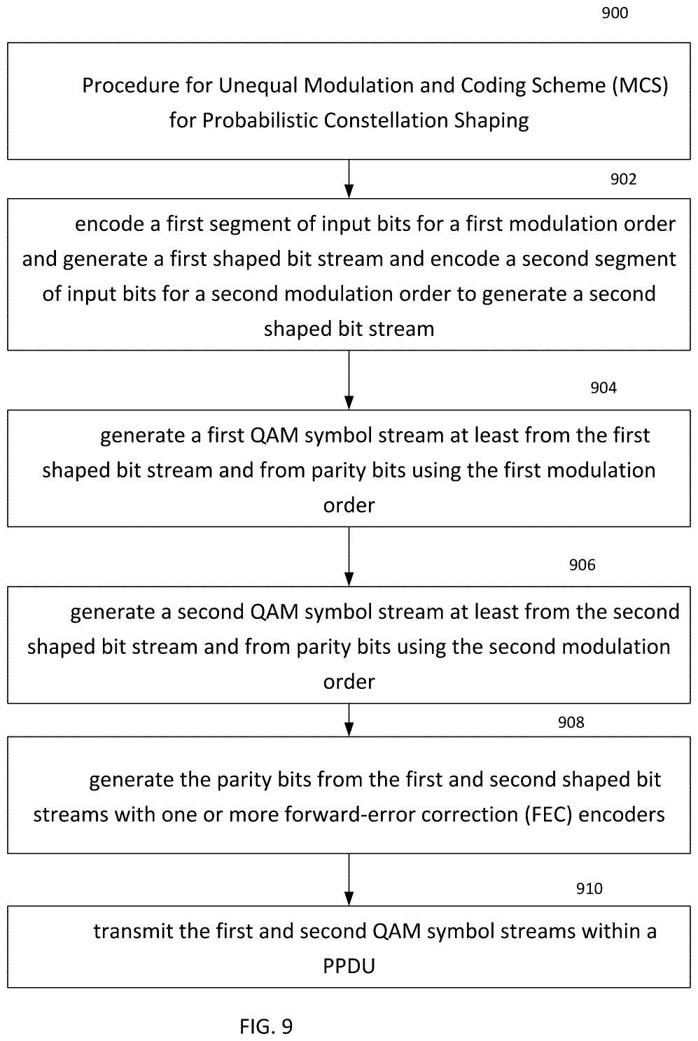

FIG. 9 illustrates a procedure for Unequal Modulation and Coding Scheme (MC S) for Probabilistic Constellation Shaping, in accordance with some embodiments. Procedure 900 may be performed by a station (STA) configured for operation in a wireless local area network (WLAN). In operation 902, the STA may perform probabilistic constellation shaping using first and second shaping encoders. The first shaping encoder may be configured to encode a first segment of input bits for a first modulation order. The STA may also generate a first shaped bit stream. The second shaping encoder may be configured to encode a second segment of input bits for a second modulation order to generate a second shaped bit stream.

In operation 904, the STA may generate a first QAM symbol stream with a first QAM modulator. The first QAM symbol stream may be generated at least from the first shaped bit stream and from parity bits using the first modulation order. In operation 906, the STA may generate a second QAM symbol stream with a second QAM modulator. The second QAM symbol stream may be generated at least from the second shaped bit stream and from parity bits using the second modulation order.

In operation 908, the STA may generate the parity bits from the first and second shaped bit streams with one or more forward-error correction (FEC) encoders. In operation 910, the STA may transmit the first and second QAM symbol streams within a PPDU.

The use of probabilistic constellation shaping in embodiments disclosed herein may provide:
Increase throughput: By shaping the constellation to favor certain signal points over others, more information can be transmitted per modulation symbol while maintaining the same average power. This improves spectral efficiency.
Improve resilience: Constellation shaping creates a non-uniform distribution of points that maximizes the minimum Euclidean distance between points. This improves resilience to noise and interference.
Reduce peak-to-average power ratio (PAPR): Shaping can minimize long sequences of high power signals, lowering PAPR in OFDM systems. This improves power amplifier efficiency.
Adapt to channel conditions: The probabilistic distribution can be optimized based on channel conditions. For good channels, throughput is maximized. For poor channels, resilience is maximized.

The use of UMC in embodiments disclosed herein may provide:
Improved network efficiency—Clients closer to the access point or in areas of good signal can use higher data rates, while poorer clients use lower rates to maintain connectivity. This improves overall throughput.
Fairness—With equal MCS, poor clients bring down data rates for all clients. Unequal MCS allows good clients to still achieve high speeds.
Backwards compatibility—When new/faster clients are added, unequal MCS allows them to achieve faster speeds via higher rates while legacy clients can connect at lower rates. An equal MCS would be limited by legacy devices.
Load balancing—Higher data rate clients finish faster, freeing up airtime for lower rate clients to get their turn. This helps balance traffic across a mixed environment.
Roaming resilience—If a client roams to an area of poorer signal, its individual rate can be lowered in real-time without affecting others. An equal MCS would require all clients reducing rates in unison.
A more efficient use of wireless network capacity in mixed environments
Improved spectral efficiency—By shaping the probability distribution of constellation points according to channel conditions, more bits can be transmitted per coherent modulation time, increasing throughput.
Increased transmission range—Shaping can allow signals to be received at lower SNRs than with uniformly spaced constellations. This effectively increases transmission range for target error rates.
Interference resilience—Optimized constellation shapes are less vulnerable to noise and interference. This improves reception in challenging radio conditions with interference.
Low implementation complexity—Unlike geometric and temporal shaping, probabilistic shaping has lower hardware complexity, making it viable with IEEE 802.11 chipsets.
Backward compatibility—Probabilistic constellation shaping maintains compatibility with existing WLAN transmission formats and requires only minor modifications to channel coding schemes.
Adaptability—The distribution shaping can be adapted dynamically based on real-time channel measurements to optimize capacity as conditions change rather than using a fixed approach.
Major capacity gains, particularly 2hen combined with MIMO, MU-MIMO and 1024+ QAM in 802.11ax/BE.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA) configured for operation in a wireless local area network (WLAN), the apparatus comprising: processing circuitry; and memory, wherein to implement an unequal Modulation and Coding Scheme (MC S) for Probabilistic Constellation Shaping, the processing circuitry is to:
perform probabilistic constellation shaping using first and second shaping encoders, the first shaping encoder configured to encode a first segment of input bits for a first modulation order and generate a first shaped bit stream, the second shaping encoder configured to encode a second segment of input bits for a second modulation order to generate a second shaped bit stream;
generate a first QAM symbol stream with a first QAM modulator, the first QAM symbol stream generated at least from the first shaped bit stream and from parity bits using the first modulation order;
generate a second QAM symbol stream with a second QAM modulator, the second QAM symbol stream generated at least from the second shaped bit stream and from parity bits using the second modulation order; and
generate the parity bits from the first and second shaped bit streams with one or more forward-error correction (FEC) encoders; and
cause the STA to transmit the first and second QAM symbol streams within a physical layer protocol data unit (PPDU).

2. The apparatus of claim 1, wherein the processing circuitry is configured to encode the PPDU to indicate that unequal MCS for probabilistic constellation shaping is to generate the first and second QAM symbol streams.

3. The apparatus of claim 2, wherein for the probabilistic constellation shaping:
the first shaping encoder determines amplitude bit tuples of a first fixed length for the first shaped bit stream by matching segments of the input bits of different lengths with table entries of a constellation shaping table for the first modulation order; and
the second shaping encoder determines amplitude bit tuples of a second fixed length for the second shaped bit stream by matching segments of the input bits of different lengths with table entries of a constellation shaping table for the second modulation order, and
wherein when the first and second modulation orders are different, the first and second fixed lengths are different.

4. The apparatus of claim 3, wherein when the first modulation order is 4K-QAM, the first fixed length for the amplitude bit tuples is five bits, and
wherein when the second modulation order is 1K-QAM, the second fixed length for the amplitude bit tuples is four bits.

5. The apparatus of claim 3, wherein each amplitude bit tuple determined by the first shaping encoder is mapped to an amplitude of an I or Q component of a QAM constellation of the first QAM modulator; and
each amplitude bit tuple determined by the second shaping encoder is mapped to an amplitude of an I or Q component of a QAM constellation of the second QAM modulator.

6. The apparatus of claim 5 wherein the one or more FEC encoders comprise one or more Low-Density Parity-Check (LDPC) encoders configured to generate parity bits for use as sign bits by the first and second QAM modulators, and
wherein the first and second QAM modulators are further configured to use input bits as sign bits.

7. The apparatus of claim 5, wherein the one or more FEC encoders comprise a single Low-Density Parity-Check (LDPC) encoder configured to generate the parity bits for use as sign bits by both the first and second QAM modulators.

8. The apparatus of claim 5, wherein the one or more FEC encoders comprise a first and a second Low-Density Parity-Check (LDPC) encoder, the first LDPC encoder configured to generate a first parity bit stream from the first shaped bit stream for use as sign bits by the first QAM modulator, the second LDPC encoder configured to generate a second parity bit stream from the second shaped bit stream for use as sign bits by the second QAM modulator, the first LDPC encoder using a first LDPC code rate, the second LDPC encoder using a second LDPC code rate,
wherein the processing circuitry is to configure the first and second LDPC encoders to use different LDPC code rates, and
wherein symbols of the first QAM symbol stream have the first LDPC code rate and symbols of the second QAM symbol stream have the second LDPC code rate.

9. The apparatus of claim 5, wherein the processing circuitry is configured to either increase or decrease an encoding rate of the one or more of the FEC encoders for filling allocated OFDM symbols.

10. The apparatus of claim 5, wherein the first and second QAM symbol streams are configured for transmission by the STA, respectively, in first and second spatial streams.

11. The apparatus of claim 5, wherein the first and second QAM symbol streams are configured for transmission by the STA, respectively, in first and second frequency subbands.

12. The apparatus of claim 5, wherein the first and second QAM symbol streams are configured for transmission by the STA, respectively, in first and second resource units (RUs) of a multiple resource unit (MRU) transmission.

13. The apparatus of claim 2, wherein for non-trigger based transmissions to indicate that unequal MCS for probabilistic constellation shaping is used to generate the first and second QAM symbol streams, the processing circuitry is configured to encode a preamble of the PPDU to specify constellation shaping and indicate the modulation orders and code rate of the each of the QAM symbol streams in a user field of a signal field (SIG) of the PPDU.

14. The apparatus of claim 2, when the STA is operating as a receiving STA, and wherein to decode first and second QAM symbol streams received from a transmitting STA when an unequal Modulation and Coding Scheme (MCS) for Probabilistic Constellation Shaping is implemented using two or more FEC encoders, the processing circuitry is configured to synchronize decoding for ordering decoded bits before reporting the decoded bits to a MAC layer of the STA.

15. The apparatus of claim 2, wherein the STA is one of an access point station (AP) and a non-Access Point station (non-AP STA).

16. A non-transitory computer-readable storage medium that stores instructions for execution by processing circuitry a station (STA) configured for operation in a wireless local area network (WLAN), wherein to implement an unequal Modulation and Coding Scheme (MCS) for Probabilistic Constellation Shaping, the processing circuitry is to:
perform probabilistic constellation shaping using first and second shaping encoders, the first shaping encoder configured to encode a first segment of input bits for a first modulation order and generate a first shaped bit stream, the second shaping encoder configured to encode a second segment of input bits for a second modulation order to generate a second shaped bit stream;
generate a first QAM symbol stream with a first QAM modulator, the first QAM symbol stream generated at least from the first shaped bit stream and from parity bits using the first modulation order;
generate a second QAM symbol stream with a second QAM modulator, the second QAM symbol stream generated at least from the second shaped bit stream and from parity bits using the second modulation order; and
generate the parity bits from the first and second shaped bit streams with one or more forward-error correction (FEC) encoders; and
cause the STA to transmit the first and second QAM symbol streams within a physical layer protocol data unit (PPDU).

17. The non-transitory computer-readable storage medium of claim 16, wherein the processing circuitry is configured to encode the PPDU to indicate that unequal MCS for probabilistic constellation shaping is to generate the first and second QAM symbol streams.

18. The non-transitory computer-readable storage medium of claim 17, wherein for the probabilistic constellation shaping:
the first shaping encoder determines amplitude bit tuples of a first fixed length for the first shaped bit stream by matching segments of the input bits of different lengths with table entries of a constellation shaping table for the first modulation order; and
the second shaping encoder determines amplitude bit tuples of a second fixed length for the second shaped bit stream by matching segments of the input bits of different lengths with table entries of a constellation shaping table for the second modulation order,
wherein when the first and second modulation orders are different, the first and second fixed lengths are different,
wherein each amplitude bit tuple determined by the first shaping encoder is mapped to an amplitude of an I or Q component of a QAM constellation of the first QAM modulator, and
each amplitude bit tuple determined by the second shaping encoder is mapped to an amplitude of an I or Q component of a QAM constellation of the second QAM modulator.

19. A method performed by processing circuitry a station (STA) configured for operation in a wireless local area network (WLAN), wherein to implement an unequal Modulation and Coding Scheme (MCS) for Probabilistic Constellation Shaping, the method comprising:
performing probabilistic constellation shaping using first and second shaping encoders by configuring the first shaping encoder to encode a first segment of input bits for a first modulation order and generate a first shaped bit stream and configuring the second shaping encoder to encode a second segment of input bits for a second modulation order to generate a second shaped bit stream;
generating a first QAM symbol stream with a first QAM modulator, the first QAM symbol stream generated at least from the first shaped bit stream and from parity bits using the first modulation order;
generating a second QAM symbol stream with a second QAM modulator, the second QAM symbol stream generated at least from the second shaped bit stream and from parity bits using the second modulation order; and
generating the parity bits from the first and second shaped bit streams with one or more forward-error correction (FEC) encoders; and
causing the STA to transmit the first and second QAM symbol streams within a physical layer protocol data unit (PPDU).

20. The method of claim 19 comprising encoding the PPDU to indicate that unequal MCS for probabilistic constellation shaping is to generate the first and second QAM symbol streams.
